(19) United States
(12) Patent Application Publication
(10) Pub. No.: US 2008/0224870 A1
(43) Pub. Date: Sep. 18, 2008

(54) APPARATUS AND METHOD FOR MANAGING POWER OF RFID TAG

(75) Inventors: Junho Yeo, Daegu-city (KR); Josef Preishuber-Pfluegl, Klagenfurt (AU); Alex Janek, Graz (AT); Andreas Schuhai, Portschach (AT); Hae-Won Son, Daejeon-city (KR); Jae-Young Jung, Daejeon-city (KR); Gil-Young Choi, Daejeon-city (KR); Cheol-Sig Pyo, Daejeon-city (KR); Jong-Suk Chae, Daejeon-city (KR)

Correspondence Address: CANTOR COLBURN, LLP, 20 Church Street, 22nd Floor, Hartford, CT, 06103, US

(73) Assignee: Electronics and Telecommunications Research Institute, Daejeon-city (KR)

(21) Appl. No.: 12/023,821

(22) Filed: Jan. 31, 2008

(30) Foreign Application Priority Data
Mar. 14, 2007 (KR) 10-2007-0025076

(51) Int. Cl. G08B 13/14

(52) U.S. Cl. 340/572.1

(57) ABSTRACT

An apparatus and method for managing power of a radio frequency identification (RFID) tag are provided. It is possible for the apparatus for managing the power of the RFID tag to effectively reduce power consumption of the RFID tag by measuring the power strength of a radio frequency (RF) signal received from an RFID reader and adjusting a level of transmission power based on the measured power strength of the signal.

The present invention was supported by the Information Technology (IT) Research & Development (R & D) program of the Ministry of Information and Communication (MIC) [project No. 2005-S-106-02, project title: Development of Sensor Tag and Sensor Node Technologies for RFID/USN].

### CROSS-REFERENCE TO RELATED PATENT APPLICATION

This application claims the benefit of Korean Patent Application No. 10-2007-0025076, filed on Mar. 14, 2007, in the Korean Intellectual Property Office, the disclosure of which is incorporated herein in its entirety by reference.

### BACKGROUND OF THE INVENTION

1. Field of the Invention

The present invention relates to an apparatus and method for managing power of a radio frequency identification (RFID) tag, and more particularly, to an apparatus and method for managing power of an RFID tag in order to adjust the transmission power of the RFID tag which transmits a response signal to an RFID reader based on the power strength of a received signal by measuring the power strength of a radio frequency (RF) signal received from the RFID reader.

2. Description of the Related Art

A radio frequency identification (RFID) system serves to recognize, trace, and manage an object, animal, or person by contactlessly reading or recording information from or onto a tag (tag or transponder) including unique identification information by using a radio frequency. The RFID system is constructed with a plurality of tags including unique identification information and which are attached on objects or animals, and an RFID reader (reader or interrogator) for reading or writing information included in the tags.

RFID tags are classified into an active RFID tag that needs a power source, a passive RFID tag that operates due to an electromagnetic field of the reader, and a hybrid RFID tag obtained by combining the advantages of the active and passive RFID tags.

The passive RFID tag has a low cost, and it is possible to semipermanently use the passive RFID tag. However, for the passive RFID tag, a recognition distance is short, and more power is consumed by the RFID reader as compared to the active RFID tag. On the contrary, the active RFID tag can reduce the necessary power of the RFID reader and increase the recognition distance from the RFID reader.

Specifically, in the latest RFID system, an active tag capable of reading/writing information by including a processor and a memory and sensing environmental information by continuously being enabled, in addition to transmitting identification information is required.

However, since such active tag has high power consumption, the active tag has to include an onboard battery. Accordingly, it is difficult to miniaturize the active tag, and the cost of the active tag is high. Also, the lifetime of the active tag is limited due to the lifetime of the battery.

### SUMMARY OF THE INVENTION

The present invention provides an apparatus and method for managing power of a radio frequency identification (RFID) tag in order to reduce power consumption of the RFID tag by measuring the power strength of a radio frequency (RF) signal received from the RFID reader and adjusting the transmission power of a response signal that is transmitted to the RFID reader based on the power strength of the received signal.

According to an aspect of the present invention, there is provided an apparatus for managing power of an RFID (radio frequency identification) tag, the apparatus including a power manager that measures power strength of an RF (radio frequency) signal received from an RFID reader and sets power of a response signal to be transmitted to the RFID reader; and a controller that controls the power manager so that the power manager adjusts the power of the response signal based on the measured power strength of the RF signal.

According to another aspect of the present invention, there is provided an RFID (radio frequency identification) tag including a receiver that receives an RF (radio frequency) signal requesting information regarding the RFID tag from an RFID reader; a power adjuster that adjust power of a response signal to carry information corresponding to the request based on power strength of the received RF signal; and a transmitter that transmits the response signal to the RFID reader based on the adjusted power.

According to another aspect of the present invention, there is provided a method of managing power of an RFID (radio frequency identification) tag, the method including the operations of (a) measuring power strength of an RF (radio frequency) signal that is received from an RFID reader; (b) setting power of a response signal to be transmitted to the RFID reader based on the measured power strength of the RF signal in response to a control signal.

According to another aspect of the present invention, there is provided a method of managing power of an RFID (radio frequency identification) tag, the method including the operations of (a) receiving an RF (radio frequency) signal requesting information regarding the RFID tag from an RFID reader; (b) adjusting power of a response signal to carry information corresponding to the request based on power strength of the received RF signal; and (c) transmitting the response signal to the RFID reader based on the adjusted power.

According to another aspect of the present invention, there is provided a computer readable recording medium having recorded thereon a program for executing a method of managing power of an RFID (radio frequency identification) tag in a computer.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an RFID tag according to an embodiment of the present invention;

FIG. 2 illustrates a method of adjusting the transmission power of an RFID tag according to an embodiment of the present invention; and

FIG. 3 is a flowchart of a method of managing power of the RFID tag according to an embodiment of the present invention.

### DETAILED DESCRIPTION OF THE INVENTION

Other objects and advantages of the present invention will be understood in the following description, and more clearly understood in embodiments of the present invention. In addition, it is easily understood that the objects and advantages of the present invention can be embodied by means and their combination defined by the appended claims.

Hereinafter, embodiments of the present invention will be described in detail with reference to the attached drawings. Like reference numerals in the drawings denote like elements. When it is determined that the detailed descriptions of the known techniques or structures related to the present invention depart from the scope of the invention, the detailed descriptions will be omitted.

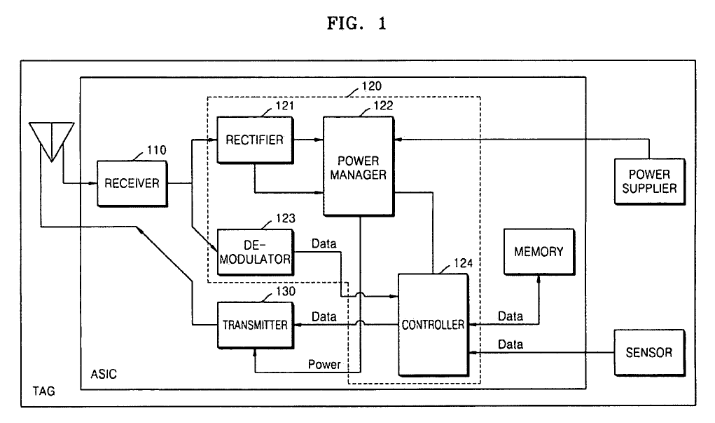

FIG. 1 is an internal block diagram illustrating an RFID tag according to an embodiment of the present invention.

Referring to FIG. 1, the RFID tag according to the embodiment includes a receiver 110, a power adjuster 120, and a transmitter 130.

The receiver 110 receives an RF signal from an RFID reader through an antenna. The RF signal may be a signal requesting the RFID tag to provide information.

The power adjuster 120 adjusts power of a response signal to carry the information corresponding to the request. The power adjuster 120, which manages power of the RFID tag, includes a rectifier 121 (RF to DC), a power manager 122, a demodulator 123, and a controller 124 (central logic).

The rectifier 121 converts a received RF power signal that is an analogue signal into a digital signal and outputs the converted signal to the power manager 122.

The power manager 122 measures the strength of a power signal that is input from the rectifier 121 and adjusts a transmission power level of the response signal in response to the request for information in correspondence with the strength of the power that is measured based on an instruction of the controller 124 that is to be described later. A transmission/receiving power level of the response/request signal is sequentially allocated at a predetermined interval in descending order in terms of power strength based on a transmission/receiving capability of the RFID tag.

The demodulator 123 demodulates data that is transmitted through an antenna and outputs the demodulated data to the controller 124. The demodulation of data may be performed, before the power manager 122 measures the power strength of the received power.

The controller 124 generates data to be transmitted (for example, a response signal) by processing the demodulated data and accessing the memory. Then, the controller 124 controls the power manager 122 so that the power manager 122 adjusts the transmission power level based on the measured power strength of the response signal. The controller 124 controls the transmitter 130 so that the transmitter transmits the response signal to the RFID reader based on the transmission power level that is adjusted by the power manager 122. If the power strength of the RF signal is high, the controller 124 determines that a communication distance with the RFID reader is short or that a communication status is good. If the power strength of the RF signal is low, the controller 124 determines that the communication distance with the RFID reader is long or that the communication status is bad. Accordingly, a received power level is inversely proportional to the transmission power level by controlling the power manager 122 so that a low transmission power level may correspond to a high receiving power level.

The transmitter 130 transmits the response signal to the RFID reader based on the set transmission power level.

The power adjuster 122 may perform the power management of the RFID tag in linkage with the RFID tag or separately from the RFID tag by constructing the power adjuster 122 together with the transmitter/receiver.

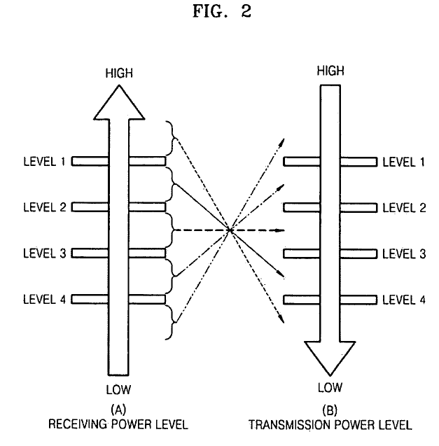

FIG. 2 illustrates a method of adjusting the transmission power of an RFID tag according to an embodiment of the present invention.

Referring to FIG. 2, level 1 is assigned to the highest power level of the receiving power level (a) and the highest power level of the transmission power level (b). As the power strength decreases, the level value increases.

The RFID tag adjusts the transmission power level of the signal to be transmitted to the RFID reader so that the transmission power level may be low when determining that a communication distance with the RFID reader is short or that a communication status is good, if the power strength of the RF signal is high. The RFID tag adjusts the transmission power level of the signal to be transmitted to the RFID reader so that the transmission power level may be high when determining that the communication distance with the RFID reader is long or that the communication status is bad, if the power strength of the RF signal is low. Accordingly, the lowest transmission power level (level 1) is allocated to the highest receiving power level (level 4).

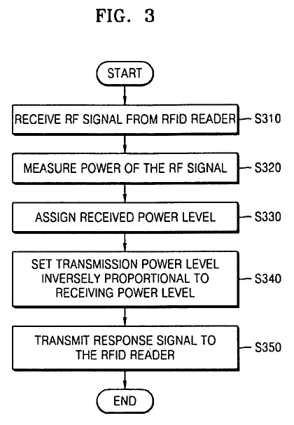

FIG. 3 is a flowchart of a method of managing power of the RFID tag according to an embodiment of the present invention. Detailed descriptions that are the same as the aforementioned contents will be omitted.

Referring to FIG. 3, the RFID tag receives an RF signal from the RFID reader (operation S310). The received RF signal may be a signal requesting information regarding the RFID tag.

Then, power strength of the received RF signal is measured (operation S320). The received RF signal is converted into a digital signal. The strength of the received power is measured from the converted digital signal. The measurement of the power strength may be performed before data included in the RF signal is demodulated.

The previously set power level is assigned to the received RF signal based on the measured power strength (operation S330). Values are sequentially allocated to the received power levels in ascending order in terms of the power strength. Each level corresponds to a range of power values with a predetermined width.

A transmission power level is set with respect to a response signal to be transmitted to the RFID reader, which is generated by processing data included in the RF signal and accessing the memory (operation S340). The transmission power level is set based on the receiving power level. As the receiving power level decreases, the allocated transmission power level increases. The transmission power level also corresponds to a range of power values with a predetermined width.

In the transmission/receiving power level, a level width and the number of levels may be determined based on a range of transmission/receiving capability of the RFID tag. In this case, the number of transmission power levels may be the same as that of the receiving power levels.

The RFID tag transmits the generated response signal to the RFID reader based on the determined transmission power level (operation S350).

The RFID tag according to an embodiment of the present invention can reduce power consumption of the RFID tag by measuring the power strength of an RF signal received from the RFID reader and adjusting the transmission power of a response signal to be transmitted to the RFID reader based on the power strength of the received signal.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by one skilled in the art that various changes in form and details may be made therein without departing from the spirit and scope of the present invention as defined by the appended claims.

While the present invention has been particularly shown and described with reference to exemplary embodiments thereof, it will be understood by one skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for managing power of an RFID (radio frequency identification) tag, the apparatus comprising:
a power manager that measures power strength of an RF (radio frequency) signal received from an RFID reader and sets power of a response signal to be transmitted to the RFID reader; and
a controller that controls the power manager so that the power manager adjusts the power of the response signal based on the measured power strength of the RF signal.

2. The apparatus of claim 1, wherein the controller controls the power manager so that the power manager allocates a receiving power level that is set for each predetermined range to the measured power strength of the RF signal and sets the transmission power level of the response signal corresponding to the receiving power level.

3. The apparatus of claim 2, wherein the controller controls the power manager so as to set the highest receiving power level in correspondence with the lowest transmission power level.

4. An RFID (radio frequency identification) tag comprising:
a receiver that receives an RF (radio frequency) signal requesting information regarding the RFID tag from an RFID reader;
a power adjuster that adjust power of a response signal to carry information corresponding to the request based on power strength of the received RF signal; and
a transmitter that transmits the response signal to the RFID reader based on the adjusted power.

5. The RFID tag of claim 4, wherein the power adjuster includes:
a power manager that measures the power strength of the received RF signal and sets the power of the response signal; and
a controller that controls the power manager so that the power manager adjusts the power of the response signal based on the measured power strength of the RF signal.

6. The RFID tag of claim 5, wherein the controller controls the power manager so that the power manager allocates a receiving power level that is set for each predetermined range to the measured power strength of the RF signal and sets the transmission power level of the response signal corresponding to the receiving power level.

7. The RFID tag of claim 6, wherein the controller controls the power manager so as to set the highest receiving power level in correspondence with the lowest transmission power level.

8. The RFID tag of claim 5, wherein the power manager measures the power strength of the RF signal before the received RF signal is demodulated.

9. A method of managing power of an RFID (radio frequency identification) tag, the method comprising:
(a) measuring power strength of an RF (radio frequency) signal that is received from an RFID reader;
(b) setting power of a response signal to be transmitted to the RFID reader based on the measured power strength of the RF signal in response to a control signal.

10. The method of claim 9, wherein (b) comprises:
(b1) allocating a receiving power level that is set for each predetermined range to the measured power strength of the RF signal; and
(b2) setting the transmission power level of the response signal corresponding to the receiving power level.

11. The method of claim 10, wherein (b2) comprises setting the highest receiving power level in correspondence with the lowest transmission power level.

12. A method of managing power of an RFID (radio frequency identification) tag, the method comprising:
(a) receiving an RF (radio frequency) signal requesting information regarding the RFID tag from an RFID reader;
(b) adjusting power of a response signal to carry information corresponding to the request based on power strength of the received RF signal; and
(c) transmitting the response signal to the RFID reader based on the adjusted power.

13. The method of claim 12, wherein (b) comprises:
(b1) measuring the power strength of the received RF signal; and
(b2) setting power of the response signal based on the measured power strength of the RF signal.

14. The method of claim 13, wherein (b2) comprises:
(b21) allocating a receiving power level that is set for each predetermined range to the measured power strength of the RF signal; and
(b22) setting the transmission power level of the response signal corresponding to the receiving power level.

15. The method of claim 14, wherein (b22) comprises setting the highest receiving power level in correspondence with the lowest transmission power level.

16. The method of claim 13, wherein (b1) comprises measuring the power strength of the RF signal before the received RF signal is demodulated.
